(19) United States
(12) Patent Application Publication
(10) Pub. No.: US 2024/0383277 A1
(43) Pub. Date: Nov. 21, 2024

(54) HUB-BEARING ASSEMBLY FOR A WHEEL OF A MOTOR VEHICLE

(71) Applicant: AKTIEBOLAGET SKF, GOTEBORG (SE)

(72) Inventors: Giancarlo BRANCA, Rivoli (IT); Marco ROMANETTO, Pianezza (IT); Fulvio Carlo NICASTRI, Garzigliana (IT); Alessandro FERRERO, Torino (IT)

(21) Appl. No.: 18/646,285

(22) Filed: Apr. 25, 2024

(30) Foreign Application Priority Data
May 16, 2023 (IT) 102023000009873

(51) Int. Cl. B60B 27/00

(52) U.S. Cl. CPC B60B 27/0078; B60B 27/0005

(57) ABSTRACT

A hub-bearing assembly having an axis of rotation includes a stationary radially outer ring and a flanged hub radially inside the radially outer ring and rotary about the axis and about the radially outer ring. The flanged hub has a toothed profile and an axially inner tubular portion. A radially inner ring is mounted in axial abutment on the flanged hub. A toothed sleeve is mounted axially close to the radially inner ring and angularly coupled to the toothed profile of the flanged hub. The flanged hub has a profile gradually transitioning between a radially outer surface of the toothed profile and a radially outer cylindrical surface of the tubular portion of the flanged hub.

### CROSS-REFERENCE

This application claims priority to Italian patent application no. 102023000009873 filed on May 16, 2023, the contents of which are fully incorporated herein by reference.

### BACKGROUND OF THE INVENTION

The present invention relates to bearings, and more particularly to a hub-bearing assembly for a wheel of a motor vehicle including a bearing unit removably coupled to a constant velocity joint suitable for use both drive and driven wheels.

Hub-bearing assemblies are known and typically include a flanged rotary hub mechanically connected to a rotary element of the motor vehicle, for example the wheel or the disk of a braking element, while the bearing unit includes an outer ring, a pair of inner rings (one of which may be the flanged hub) and a plurality of rolling bodies, for example balls. All of these components have axial symmetry about the axis of rotation of the rotary elements, for example the flanged hub and the inner rings of the bearing unit.

The flanged hub receives drive torque from the bellhousing of the constant velocity joint via a splined coupling. In particular, the bellhousing of the constant velocity joint is provided with axially outer teeth, while a toothed sleeve with axially outer teeth is fastened to the hub. The toothed sleeve and the hub are coupled together by means of an inner groove of the toothed sleeve that engages with a toothed profile of the hub that has an axial length shorter than the axial length of the inner groove.

A ring gear with axially inner teeth transmits motion from the constant velocity joint to the hub of the wheel and the ring gear is provided with a system for disconnecting from the toothed sleeve of the hub. Consequently, when the ring gear is engaged with the toothed sleeve of the hub, motion is transmitted from the transmission shaft to the wheel of the motor vehicle, which then acts as a drive wheel. Conversely, when the ring gear is disengaged from the toothed sleeve of the hub, transmission of motion from the transmission shaft to the wheel is interrupted, and the wheel acts as a driven wheel.

In this configuration, bearings are required between the hub and the constant velocity joint to enable the hub to rotate independently of the constant velocity joint. These bearings are typically radial ball bearings.

By means of a known process such as orbital roll forming, an axially inner appendage of the flanged hub is deformed to axially preload and clamp both the toothed sleeve and the radially inner ring (mounted on the flanged hub) in relation to the flanged hub itself.

Rolling the material of the flanged hub directly on the toothed sleeve causes the rolled material to be deformed and pressed against the discontinuous surface of the toothed sleeve (the internal profile of the toothed sleeve has empty spaces between the teeth). This creates non-uniform deformations and concentrations of stresses on the area of the deformed material of the flanged hub in contact with the toothed sleeve, and therefore potential starting points for cracks.

### SUMMARY OF THE INVENTION

One objective of the present invention is to provide a hub-bearing assembly that is coupled to a system for disconnecting from the transmission shaft, in which the hub comprises a gradual-transition profile designed to support the material of the rolled edge of the hub.

Therefore, the present invention provides a hub-bearing assembly having a rotation axis and comprising a stationary radially outer ring, a flanged hub radially internal to the radially outer ring and rotatable both with respect to the axis and with respect to the radially outer ring, the flanged hub having a toothed profile and a tubular portion axially internal to the toothed profile, and a radially inner ring mounted in axial abutment on the flanged hub. A toothed sleeve is mounted axially adjacent to the radially inner ring and angularly coupled with the toothed profile of the flanged hub. Further, the flanged hub has a profile of gradual transition between a radially outer surface of the toothed profile and a cylindrical surface radially external to the tubular portion of the flanged hub.

Further embodiments of the invention, which are preferred and/or particularly advantageous, are described according to the features set out in the attached dependent claims.

### BRIEF DESCRIPTION OF THE SEVERAL VIEWS OF THE DRAWINGS

The invention is described below with reference to the attached drawings, which show a non-limiting example embodiment thereof, in which:

FIG. 1 is a cross section of a hub-bearing assembly according to a preferred embodiment of the present invention;

FIG. 2 is a magnified view of a first detail of the hub-bearing assembly in FIG. 1, in which the hub is in a configuration preceding a plastic deformation process;

FIG. 3 is a magnified view of a second detail of the hub-bearing assembly in FIG. 1, in which the hub is in a configuration following a plastic deformation process;

FIG. 4 is a further magnified view of a first detail of the hub of the hub-bearing assembly in FIG. 1;

FIG. 5 is a further magnified view of a third detail of the hub-bearing assembly in FIG. 1;

FIG. 6 is a magnified view of a fourth detail of the hub-bearing assembly in FIG. 1; and

FIG. 7 is a further magnified view of a second detail of the hub of the hub-bearing assembly in FIG. 1.

### DETAILED DESCRIPTION OF THE INVENTION

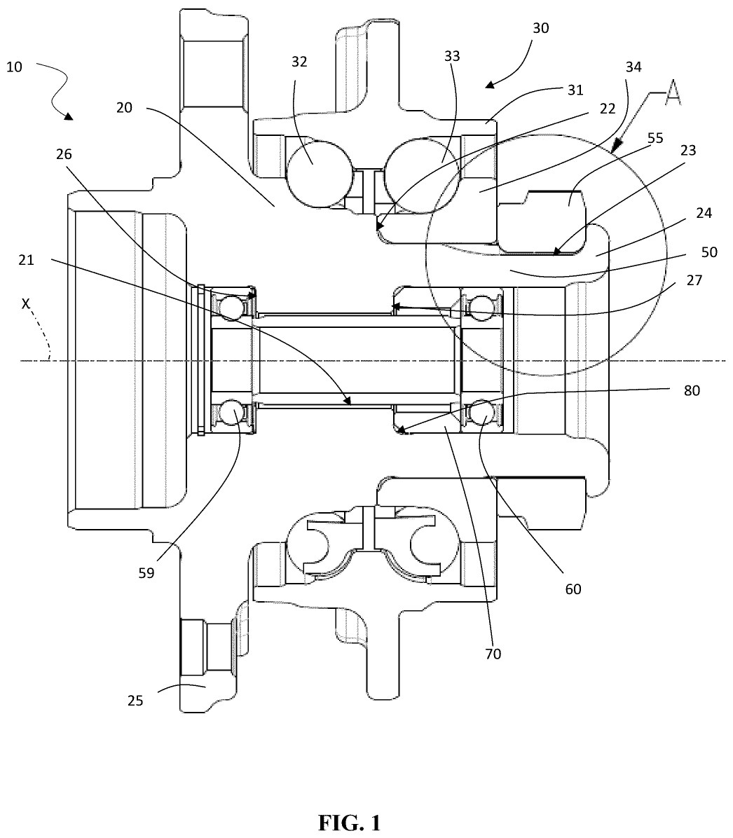

With reference to FIG. 1, a hub-bearing assembly according to a preferred embodiment of the invention is denoted as a whole using reference sign 10. When in use, the hub-bearing assembly 10 is interposed between a wheel and a frame of the vehicle, both of which are known and not illustrated, and may be coupled selectively to a constant velocity joint, which is also known and not illustrated, by means of a transmission device, which is again known and not illustrated, to transmit or otherwise the drive torque to the respective wheel.

The hub-bearing assembly 10 comprises a rotary flanged hub 20 and a bearing unit 30 having a central axis of rotation X. The bearing unit 30 includes a stationary radially outer ring 31, a radially inner ring 20 defined by the flanged hub 20 and another radially inner ring 34 mounted on and rigidly connected to the flanged hub 20. Both of the radially inner rings 20, 34 are rotary or rotatable with respect to the radially outer ring 31 as a result of the interposition of two rows of rolling bodies 32, 33. Preferably, the rolling bodies 32, 33 are balls, but may be alternatively be any other appropriate rolling elements, such as for example, cylindrical rollers, tapered rollers, needles, etc.

As used throughout the present description and in the claims, terms and expressions indicating positions and orientations, such as “radial” and “axial”, are to be understood with reference to the central axis of rotation X of the bearing unit 30. On the other hand, expressions such as “axially outer” and “axially inner” refer to the mounted state of the hub-bearing assembly, and in this case preferably refer to a wheel side as “axially outer” and to a side opposite the wheel side as “axially inner”.

The flanged hub 20 has a central through-hole 21 that extends along the axis X and is configured to be engaged by the constant velocity joint. The flanged hub 20 includes a flange 25 on an axially outer side of the hub 25 for fastening a wheel of the vehicle (neither shown) to the hub-bearing assembly 10. The flanged hub 25 has a rolled edge 24 on an axially inner side of the hub 20, the rolled edge 24 preferably being obtained by orbital roll forming and is designed to axially preload both the inner ring 34 and a toothed sleeve 55 against a radially outer shoulder 22 of the flanged hub 20. The toothed sleeve 55 is mounted close to or adjacent to the inner ring 34, is coupled by means of an inner groove 56 to a toothed profile 23 of the flanged hub 20, and is part of a known transmission device connected or disconnected by means of an outer toothed profile 57 of the sleeve 55.

Bearings are required between the hub 20 and the constant velocity joint to enable the flanged hub 20 to rotate independently of the constant velocity joint when the flanged hub 20 is disengaged from the constant velocity joint. In the embodiment of the present invention, the flanged hub 20 has a first radially inner shoulder 26 and a second radially inner shoulder 27 formed inside the central through-hole 21, and at least two radial ball bearings 59, 60 are mounted adjacent to each shoulder 26, 27, respectively (two bearings being shown in the configuration illustrated in FIG. 1). The two radial ball bearings 59, 60 are mounted in a radially inner position with respect to the flanged hub 20. Specifically, the first radial ball bearing 59 is mounted in an axially outer position against the first shoulder 26 and the second radial ball bearing 60 is mounted in an axially inner position against the second shoulder 27. Further, there may also be a second radial ball bearing in the axially inner position.

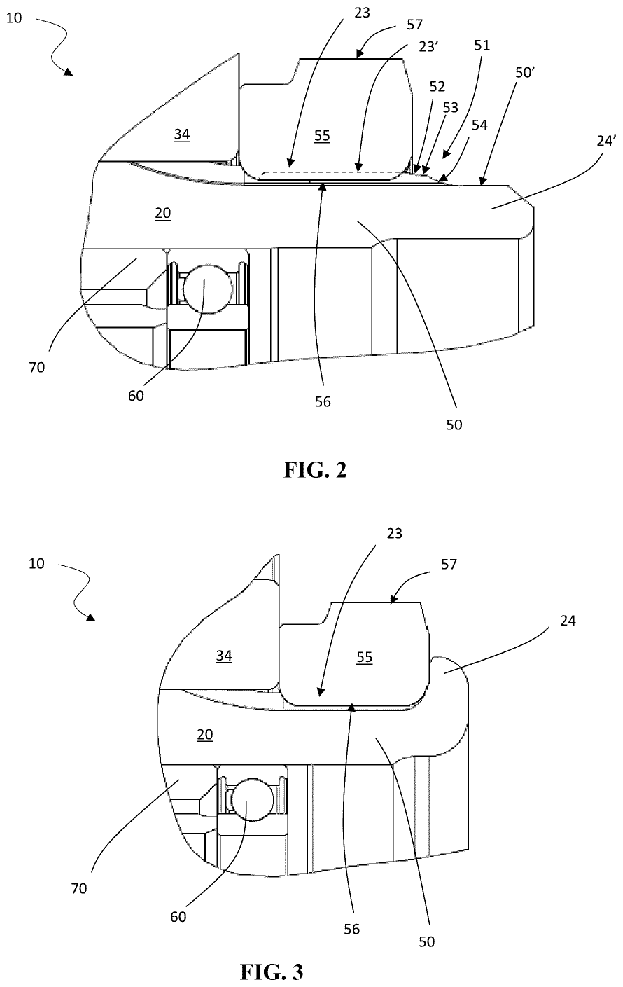

FIGS. 2 and 3 show a detail of the hub-bearing assembly 10, and in particular of an axially inner tubular portion 50 of the flanged hub 20 respectively before and after the orbital roll forming operation. FIG. 2 shows an end edge 24′ of the tubular portion 50 of the flanged hub 20 before orbital roll forming, and FIG. 3 shows the rolled edge 24 of the flanged hub 20 after the orbital roll forming operation. Further, FIG. 4 shows a detail of the tubular portion 50 of the flanged hub 20 only (i.e., without the sleeve 55 and inner ring 34) before the orbital roll forming operation.

With reference to FIGS. 2-4, according to the present invention, the flanged hub 20 has a novel shape of the tubular portion 50 thereof which is provided to improve the distribution of the material during the orbital roll forming operation. In particular, the tubular portion 50 includes a radially outer profile 51 transitioning gradually between a radially outer surface 23′ of the toothed profile 23 of the flanged hub 20 and a radially outer cylindrical surface 50′ of the tubular portion 50 of the flanged hub 20. The surface 23′ is an ideal cylindrical surface tangent to the tips of the teeth of the toothed profile 23.

This gradual-transition profile 51 is formed by increasing the axial length of the toothed profile 23 of the flanged hub 20 and making the toothed profile 23 almost the same axial length as the inner groove 56 of the toothed sleeve 55 and by adding connection surfaces between the surface 23′ of the toothed profile 23 and the cylindrical surface 51 of the tubular portion 50.

In particular, the gradual-transition profile 51 includes a first curvilinear surface 52 that is axially inside and extends from the surface 23′ of the toothed profile 23, a cylindrical surface 53 that is axially inside and extends from the first curvilinear surface 52, and a cylindrical surface 54 that is axially inside and extends from the cylindrical surface 53 (the point of transition between the cylindrical surface 53 and the second curvilinear surface 54 is indicated as “P” in FIG. 4) and that is axially outside and extends from the cylindrical surface 50′.

As a result, the thickness of the tubular portion 50 of the flanged hub 20 lessens or reduces gradually and almost continuously from a thickness S at the toothed profile 23 to a (lesser) thickness S′ at the rolled edge 24′, as indicated in FIG. 4.

The shape of the gradual-transition profile 51 enables a greater amount of material in the tubular portion 50, i.e., within the profile 51 itself, such material at least partially filling the empty spaces in the inner groove 56 of the toothed sleeve 55. Furthermore, the greater availability of material of the tubular portion 50 at the profile 51 helps to better support the material of the rolled edge 24 during the orbital roll forming operation. In fact, in previously known solutions, the absence of the profile 51 and therefore of a gradual transition of the thickness of the tubular portion 50 means that the material of the rolled edge is able to bend freely with no guidance during the orbital roll forming operation, creating local defects caused by the bending of the material and the compression of the empty spaces between the teeth of the toothed sleeve.

To optimize the desired effect, i.e., a gradual reduction in the thickness of the tubular portion 50, finite element analyses and experimental evidence have shown that the profile 51 should advantageously be formed so that:
the first curvilinear surface 52 has a radius of curvature of between 6 mm and 7 mm;
the second curvilinear surface 54 has a radius of curvature of between 4 mm and 6 mm; and
the cylindrical surface 53 has an axial length not exceeding (i.e., no greater than) 0.5 mm, primarily for reasons of technological requirements.

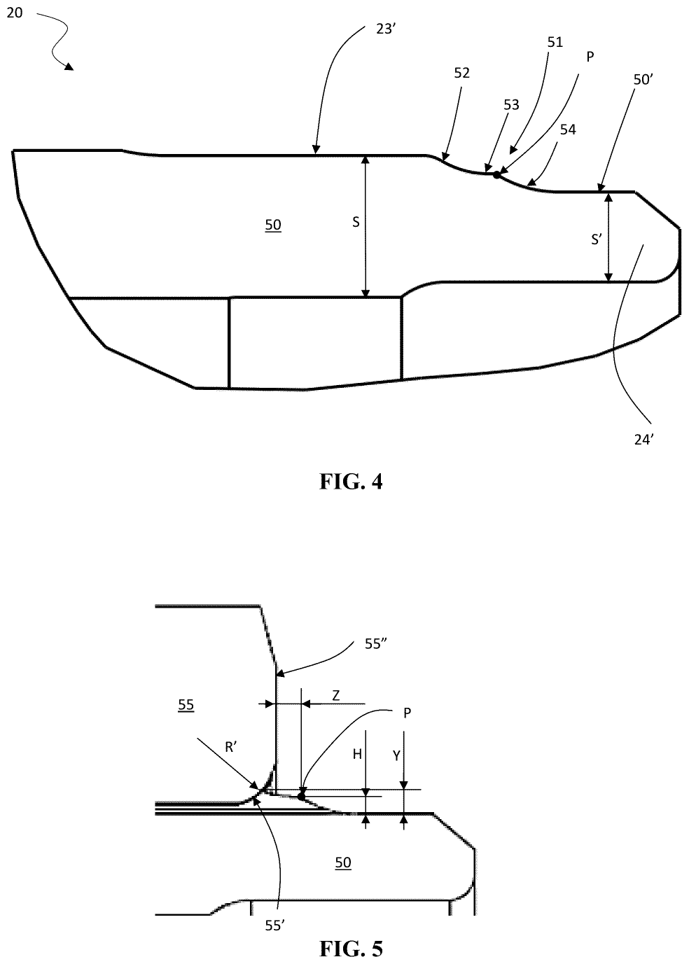

With reference to FIG. 5, the same finite element analyses and experimental evidence have optimized the radial position and the axial position of the gradual-transition profile 51. To determine this position, the point P of continuity between the cylindrical surface 53 and the second curvilinear surface 54 of the profile 51 was used as reference.

The radial position of the point P is defined as a function of the toothed profile 23 of the flanged hub 20. In particular, where Y indicates the height of the toothed profile 23, i.e. the distance between the top surface 23′ of the toothed profile 23 and the cylindrical surface 50′ of the tubular portion 50, and H indicates the distance determining the radial position of the point P in relation to the cylindrical surface 50′ of the tubular portion 50, the following relationship must be true:

$$0.4 \times Y < H < 0.6 \times Y ( {}^{″} {x}^{″} indicating multiplication )$$

The axial position of the point P is defined as a function of two surfaces of the toothed sleeve 55. Specifically, a function of an axially inner annular surface 55″ and a curvilinear surface 55′ having a radius of curvature R′ and that connects the annular surface 55″ with the inner groove 56 of the toothed sleeve 55.

The axial distance Z of the point P from the annular surface 55″ of the toothed sleeve 55 has the following relationship as a function of the radius of curvature R′ of the curvilinear surface 55′:

$$0.25 \times {R}^{′} < Z < 0.75 \times {R}^{′} ( {}^{″} {x}^{″} indicating multiplication )$$

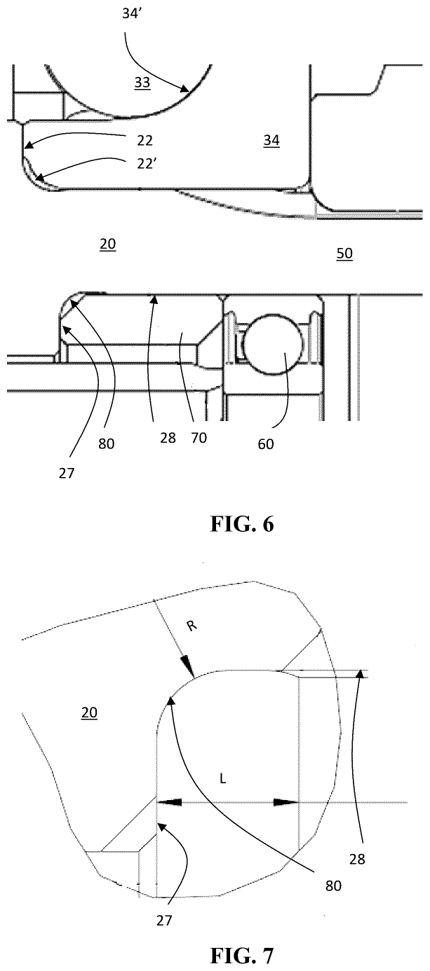

With reference to FIG. 6, the axial stop for the second radial ball bearing 60 is advantageously formed by a spacer 70 radially inside the flanged hub 20 and axially outside the radial ball bearing 60. The spacer 70 is in turn axially blocked against, or disposed against, the second axial shoulder 27 of the flanged hub 20.

More specifically, the two radial bearings 59, 60 and the spacer 70 are pressed by a ring (known and not illustrated) against the shoulders 26, 27, exerting axial compression forces through the outer rings of the bearings 59, 60 and the spacer 70 onto the flanged hub 20 that, in response to the stresses transmitted by the wheel, generate reactive forces on the shoulders 26, 27 and in particular on the axially inner second shoulder 27 since the shoulder 27 is located in the most highly stressed part of the flanged hub 20, i.e., the tubular portion 50.

The presence of the spacer 70 helps to improve the geometry of the flanged hub 20 in terms of tension. Indeed, to enable grinding operations to be carried out on the radially inner seat 28 of the flanged hub 20, which accommodates the second radial ball bearing 60 and the spacer 70, a relief groove 80 has to be defined between the seat 28 and the second axial shoulder 27 of the flanged hub 20. The relief groove 80 is therefore axially outside the seat 28 and radially inside the entire flanged hub 20. The presence of the spacer 70 enables the relief groove 80 to be sufficiently distant from the tubular portion 50 of the flanged hub 20.

Consequently, the inclusion of the spacer 70, which is used as an axial shoulder for the axially inner radial ball bearing 60, is primarily intended to enable the provision of a radially inner relief groove 80 that is different in shape and position compared to a relief groove that could be provided without the spacer 70.

The inclusion of the spacer 70 provides numerous advantages:
the radially inner relief groove 80 is provided in a more axially outer position, which is therefore further away from the tubular portion 50 of the flanged hub 20, which is the most stressed zone of the hub;
the geometry of the relief groove 80 is characterized by larger radii and a greater overall length, with a consequent reduction in the notch effect; and
where required for a particular application, it is also possible to include a second axially inner radial ball bearing in addition to the first axially inner ball bearing 60, without modifying the flanged hub 20 but merely reducing the axial dimension or length of the spacer 70. The second axially inner radial ball bearing may be useful where one ball bearing 60 is not enough to withstand the stresses generated by the constant velocity joint.

With reference to FIG. 7, the geometric parameters for optimizing the relief groove 80 and eliminating the structural problems of the flanged hub 20 are:
the geometry of the groove 80 itself. The radius R of the relief groove 80 should preferably be between 1.8 mm and 2.2 mm, while the axial length L can preferably vary between 3.8 mm and 4.2 mm; and
the axial position of the relief groove 80. The limit positions, both on the axially inner side and the axially outer side, may be advantageously identified to avoid structural criticalities.

Definitively, the gradual-transition profile 51 between the top surface 23′ of the toothed profile 23 and the cylindrical surface 50′ of the tubular portion 50 provides the following advantages:
greater availability of material of the tubular portion 50 at the profile 51 helps to better support the material of the rolled edge 24 during the orbital roll forming operation;
no deformations are induced on the radially inner ring 34 that could alter the raceway 34′ of the ring 34 and modify the osculation thereof. The absence of deformations induced on the radially inner ring 34 reduces fatigue stresses between the rolling bodies and the raceway, increasing the service life of the hub-bearing assembly 10; and
the greater strength of the rolled edge 24 enables greater application loads on the bearing unit 30 without the need to increase the dimensions thereof.

The use of the spacer 70 together with the gradual transition zone 53 provides further advantages:
greater robustness of the flanged hub 20 in the zone between the shoulder 27 and the rolled edge 24, i.e., in the most structurally stressed zone, improving the capacity thereof to withstand loads; and
the solution is flexible in that the length of the spacer 70 can be modified to enable two axially inner radial ball bearings to be inserted without modifying the design of the flanged hub 20. In fact, the decision to use one or two axially inner radial ball bearings (i.e., in addition to the axially outer radial ball bearing 59) may be made at any stage of development without resulting in or requiring design modifications to the flanged hub 20.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A hub-bearing assembly having a rotation axis and comprising:
a stationary radially outer ring;
a flanged hub radially internal to the radially outer ring and rotatable both with respect to the axis and with respect to the radially outer ring, the flanged hub having a toothed profile and a tubular portion axially internal to the toothed profile;
a radially inner ring mounted in axial abutment on the flanged hub; and
a toothed sleeve mounted axially adjacent to the radially inner ring and angularly coupled with the toothed profile of the flanged hub;
wherein the flanged hub has a profile of gradual transition between a radially outer surface of the toothed profile and a cylindrical surface radially external to the tubular portion of the flanged hub.

2. The assembly according to claim 1, wherein the toothed profile of the flanged hub has the same axial length as an inner groove of the toothed sleeve.

3. The assembly according to claim 1, wherein the profile includes:
a first curvilinear surface axially internal to and in continuity with the surface of the toothed profile;
a cylindrical surface axially internal to and in continuity with the first curvilinear surface; and
a second curvilinear surface axially internal to and in continuity with the cylindrical surface and axially external to and in continuity with the cylindrical surface.

4. The assembly according to claim 3, wherein the first curvilinear surface of the profile has a radius of curvature with a value of between six millimeters and seven millimeters.

5. The assembly according to claim 3, wherein the second curvilinear surface of the profile has a curvature radius with a value of between four millimeters and six millimeters.

6. The assembly according to claim 3, wherein the cylindrical surface of the profile has an axial length with a value of no greater than one-half millimeter.

7. The assembly according to claim 1, wherein the flanged hub is provided with a first shoulder, a second shoulder and a seat axially delimited by the second shoulder, the first and second shoulders and the seat being radially internal on the hub and the seat being formed in an axially internal position of the hub, and the assembly further comprises:
a first radial ball bearing radially internal with respect to the hub and mounted in an axially outer position against the first shoulder of the hub;
at least one second radial ball bearing radially internal with respect to the hub and mounted in an axially inner position against the second shoulder of the hub, the at least one second bearing being mounted inside the seat; and
a spacer mounted inside the seat in an intermediate position between the second shoulder and the at least one second radial ball bearing, the spacer being arranged in axial abutment against the second shoulder.

8. The assembly according to claim 7, wherein the at least one second radial ball bearing includes a single second radial ball bearing.

9. The assembly according to claim 7, wherein the at least one second radial ball bearing includes two second radial ball bearings and the spacer has an axial dimension sized such that the spacer extends between the second shoulder and the two second radial ball bearings.
